(19) United States
(12) Patent Application Publication
(10) Pub. No.: US 2010/0032053 A1
(43) Pub. Date: Feb. 11, 2010

(54) Container lining device and method for using the same

(76) Inventors: Mokchuan Chong, Hui Zhou City (CN); Charles W. True, Houston, TX (US)

Correspondence Address: GUANGZHOU SCIHEAD PATENT AGENT CO., LTD.;Room 1508 Huihua, Commercial & Trade bldg., No. 80 Xianlie Zhong Road, Guangzhou, Guangdong, 510070, CN

(21) Appl. No.: 12/461,035

(22) Filed: Jul. 30, 2009

(30) Foreign Application Priority Data
Aug. 1, 2008 (CN) 200810029957.3

(51) Int. Cl. B65B 3/04; B65D 25/14; B67D 7/00

(52) U.S. Cl. 141/10; 220/495.06; 222/1

(57) ABSTRACT

A container lining device and a method for using the same are disclosed. The container lining device for being installed in a container includes a sealed rectangular bag made of a pliable material and having a single-layer or multi-layer bag wall. The bag has a front side centrally provided with a valve, and a rear side provided transversely and longitudinally with plural pulling straps whose free ends extend out from edges of the bag. Liquid or fluid cargo is delivered into and out of the container lining device through the valve. After unloading, the container lining device is taken out through an opening of the container and replaced by another such container lining device to facilitate reloading. The container lining device facilitates saving the time and cost otherwise required for cleaning the container, increasing the utilization rate and service life of the container, and lowering overall cargo transportation costs.

### BACKGROUND OF THE INVENTION

1. Technical Field

The present invention relates to storage techniques for transportation purposes. More particularly, the present invention relates to a lining device for use in a container and a method for using the lining device.

2. Description of Related Art

Nowadays, food or chemical cargo in liquid or fluid form that is stored in containers and transported by land, sea, or air is subject to very stringent purity requirements. It is also required that cargo containers take certain protection measures. For example, the tank of a tank truck must be thoroughly cleaned and purged of residual liquid before reloading so that the newly loaded cargo will not be contaminated and is ensured of high purity. As this kind of tanks are often huge and have complicated internal structure, they can only be cleaned at professional facilities. However, these facilities are relatively small in number and are, in most cases, far from cargo loading sites. Tank trucks may have to wait in line after they get to the facilities and before the time-consuming cleaning operation begins. As a result, the utilization rates of the tanks are lowered due to the considerable amount of time taken by the entire tank-cleaning process. Besides, the charge of each tank-cleaning session is so high that the overall cargo transportation costs cannot be reduced. Other containers for transportation purposes are also faced with similar problems.

### BRIEF SUMMARY OF THE INVENTION

In view of the aforesaid problems with existing containers, it is an objective of the present invention to provide a container lining device and a method for using the same so that liquid or fluid cargo can be loaded and unloaded with enhanced efficiency by replacing the container lining device installed in a container.

In order to achieve the above and other objectives, the present invention provides a container lining device which includes a sealed bag made of a pliable material and provided with a valve.

The bag may be provided with one or more such valves.

The bag has a single-layer or multi-layer bag wall.

The bag is provided with one or more pulling straps.

The bag is rectangular, and the valve is provided at a central portion of a front side of the rectangular bag. Each of the pulling straps has a free end extending out from an edge of the bag.

The method for using the container lining device includes the following steps:

(1) Covering protruding portions and valves at an inner bottom of a container with plastic material;

(2) Folding the bag of the container lining device into a strip and then putting the same into the container through a loading opening of the container while the free end of the pulling strap is held, so that the bag reaches the inner bottom of the container;

(3) Injecting liquid into the bag through the valve with a hose; and

(4) Drawing the liquid out of the bag through the valve with a hose.

The method further includes a step (3b) between the steps (3) and (4), wherein the step (3b) is filling air or an inert gas into a gap between the bag and the container.

The method further includes a step (4b) following the step (4), wherein the step (4b) is sucking up the residue in the bag with a suction hose.

The container lining device of the present invention can be installed in a container, such as a tank, so that liquid or fluid cargo is delivered into and out of the bag through the valve. After unloading, the container lining device is taken out of the container through a loading opening thereof and replaced by another such container lining device so that reloading can be carried out immediately. The container lining device facilitates saving the time and cost otherwise required for cleaning the container, increasing the utilization rate of the container, lowering the overall cargo transportation costs, and extending the service life of the container.

### BRIEF DESCRIPTION OF THE SEVERAL VIEWS OF THE DRAWINGS

The invention as well as a preferred mode of use, further objectives, and advantages thereof will be best understood by referring to the following detailed description of an illustrative embodiment in conjunction with the accompanying drawings, wherein:

FIG. 1 is a perspective view of a container lining device according to the present invention when loaded;

FIG. 2 is a perspective view showing the container lining device of FIG. 1 in use, wherein a tank holding the container lining device is partially cut away;

FIG. 3 is a sectional view showing a folded bag of the present invention being put into the tank;

FIG. 4 is a sectional view showing the bag of the present invention being inflated before loading;

FIG. 5 is a sectional view showing the container lining device of the present invention being loaded; and

FIG. 6 is a sectional view showing a suction hose sucking a residue out of the container lining device of the present invention.

### DETAILED DESCRIPTION OF THE INVENTION

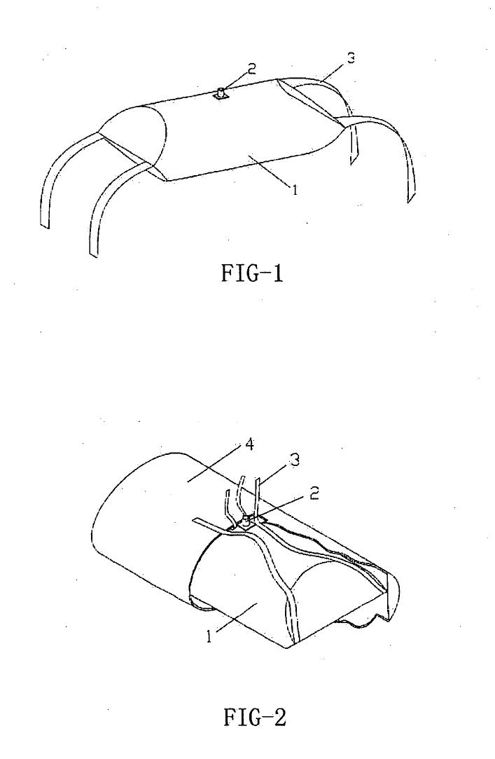

Referring to FIG. 1 and FIG. 2, a container lining device according to the present invention includes a sealed rectangular bag 1 made of a pliable material. The bag 1 has a two-layer or multi-layer bag wall. At least one valve 2 is provided at a central portion of a front side of the bag 1 and configured for the input and output of gas and the loading and unloading of cargo. A plurality of pulling straps 3 are provided transversely and longitudinally on a rear side of the bag 1 and have free ends extending out from edges of the bag 1.

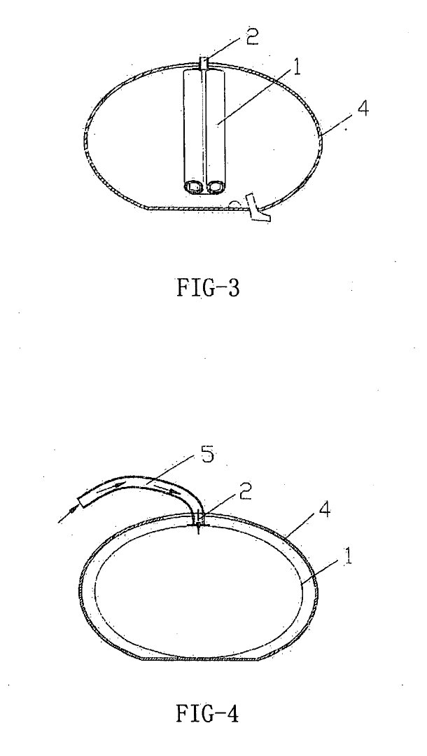

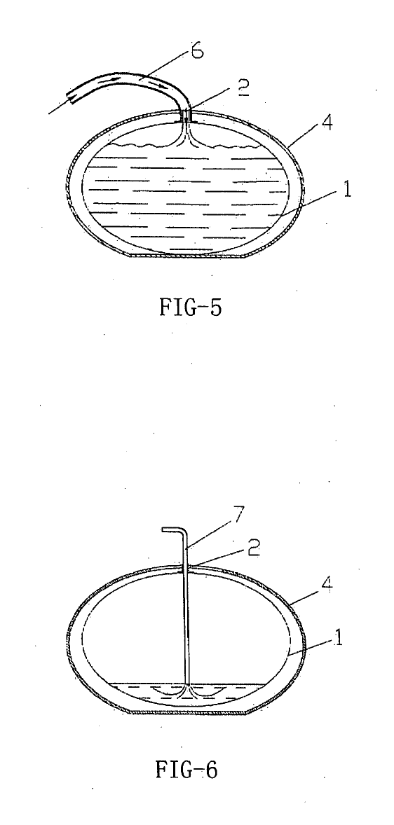

A method for using the container lining device in a container, such as a tank 4 of a tank truck, is herein described by reference to FIGS. 3 through 6.

To begin with, protruding portions and valves at an inner bottom of the tank 4 are covered with plastic material, so that the container lining device, once settled in the tank 4 and loaded with liquid, is protected from being cut or punctured. The container is folded into a strip and then placed into the tank 4 through a loading opening thereof while the free ends of the pulling straps 3 are held, for example, by an operator. The bag 1 is slowly lowered onto the inner bottom of the tank 4 so that the valve 2 on the front side of the bag 1 faces up. Next, an inflation hose 5 is inserted into the bag 1 through the valve 2 so as to pump gas into the bag 1. As the bag 1 gradually inflates, the valve 2 rises to a position adjacent to the loading opening of the tank 4 to facilitate subsequent loading operation. It should be noted that a skillful operator can use a feeding hose 6 to inject liquid or fluid cargo into the bag 1 without inflating the bag 1 in advance. After the liquid or fluid cargo is injected into the bag 1 with the feeding hose 6, if the cargo takes up only 80% or so of the inner volume of the bag 1, it is necessary to draw the gas out of the bag 1 through the valve 2 with an exhaust hose; if the cargo occupies about 95% of the inner volume of the bag 1, the gas in the bag 1 can be pressed out by the weight of the bag 1 itself. In order to prevent collision between the container lining device and the tank 4 during transportation, air or an inert gas is injected through a gas inlet of the tank 4 and fills up the gap between the container lining device and the tank 4 so that the container lining device is secured in place by the pressure of the air or the inert gas.

The cargo is unloaded from the bag 1 through the valve 2 with an unloading hose. Residue of the cargo is sucked out of the bag 1 with a suction hose 7. If there is still residue remaining in the bag 1, the pulling straps 3 can be pulled upward, thus forcing the residue to gather at a central portion of the bag 1 of the container lining device so that the residue can be sucked out completely. Finally, the used container lining device is discarded.

When the container lining device is used in a carriage of a train, it is also necessary to lay a plastic plate on the carriage floor to cover sharp projections on the carriage floor. When the container lining device is used in other containers, similar measures are required, too.

In a different embodiment, there is only one valve 2 provided on the bag 1, and the single valve 2 serves as an inlet/outlet port for both gas and cargo. Besides, the bag 1 of the container lining device may have a single-layer or multi-layer bag wall. However, it is more reasonable for the bag 1 to have a two-layer bag wall that not only guarantees robustness and tightness of the container lining device but also avoids complex technology and excessively high costs.

The present invention is herein described by reference to the preferred embodiment, and it is understood that the embodiment is not intended to limit the scope of the present invention. A person skilled in the art may modify the disclosed embodiment without departing from the concept of the present invention. Therefore, all equivalent modifications based on the concept of the present invention should be encompassed by the appended claims.

1. A container lining device, comprising a sealed bag made of a pliable material, wherein the bag is provided with a valve.

2. The container lining device of claim 1, wherein the bag is provided with one or more said valves.

3. The container lining device of claim 1, wherein the bag has a single-layer or multi-layer bag structure.

4. The container lining device of claim 1, wherein the bag has one or more pulling straps.

5. The container lining device of claim 1, wherein the bag is rectangular, and the valve is provided at a central portion of a front side of the rectangular bag, a free end of the pulling strap extends out from an edge of the bag.

6. A method for using the container lining device of claim 5, comprising steps of:
(1) covering protruding portions and valves at an inner bottom of a container with plastic material;
(2) folding the bag of the container lining device into a strip and then placing the folded bag into the container while holding the free end of the pulling strap, so that the bag reaches the inner bottom of the container;
(3) injecting a liquid into the bag through the valve with a hose; and
(4) drawing the liquid out of the bag through the valve with a hose.

7. The method of claim 6, further comprising, between the steps (3) and (4), a step (3b) of filling air or an inert gas into a gap between the bag and, the container.

8. The method of claim 6, further comprising, after the step (4), a step (4b) of sucking up a residue in the bag with a suction hose.
